(19) United States
(12) Patent Application Publication
(10) Pub. No.: US 2026/0154751 A1
(43) Pub. Date: Jun. 4, 2026

(54) Key Employee Retention Insurance, Method & Apparatus Devices

(71) Applicant: Stephen L. Nerheim, Alamo, CA (US)

(72) Inventor: Stephen L. Nerheim, Alamo, CA (US)

(21) Appl. No.: 18/967,379

(22) Filed: Dec. 3, 2024

(51) Int. Cl. G06Q 40/08

(52) U.S. Cl. CPC G06Q 40/08

(57) ABSTRACT

The Key Employee Retention Insurance Policy (product of the invention) is designed to insure the contractually obligated financial risks contained within a Key Employee Retention Employment Contract. It is conceivable that some other company(ies) may develop or write employment contracts and insurance policies with defined incentives and/or defined claim “triggering events” that vary from those presented in this patent application and or provided sample contracts; or name their programs to not include the words “Key Employee Retention.” The overarching premise of this invention is the creation, via insurance calculation implementation and delivery platform of an insurance policy, to cover the financial risks associated with a company entering into a contract with an employee within which the company is creating a financial obligation as an incentive to employees to remain employed with the company until reaching the contractually defined retirement age or permutation therein contained in the contract.

### TECHNICAL FIELD

Various embodiments relate to novel insurance products, insurance platforms, novel insurance products, and novel insurance product calculation, implementation and delivery methods.

### BACKGROUND

Problem: Companies across multiple industries have been struggling for years to retain great employees. Companies hire bright young talent, then spend years mentoring and training them to reach their potential in their particular industry, and then these employees leave the company for a position with a competitor for a relatively small raise in their salary. These employees'departure has significant financial impact on the company. While there exist several key employee retention incentive programs available for companies to enroll in and fund, non are offer tailored fit for the employer, employee or both, and are relatively expensive and tax prohibitive for the company.

Solution: Develop an Invention that provides insurance to cover the financial risks taken on by a Company that enters into a Key Employee Employment Contract (Contract) with a Key Employee (Employee) the Company chooses to provide incentivization to remain with the Company. The invented Key Employee Retention Insurance policy (Product) then follows the Contract between the Company and its Employee which details the financial risks taken on by the Company's commitment to (1) provide specific financial obligations to the Employee upon remaining with the company until retirement age as stated in the Contract. The Contract will also specify Company's financial obligations to the Employee in the event of (2) permanent disability, (3) economically forced reduction in staffing levels and (4) Employee's death.

The Key Employee Retention Insurance Policy (product of the invention) is designed to insure the contractually obligated financial risks contained within a Key Employee Retention Employment Contract. It is conceivable that some other company(ies) may develop or write employment contracts and insurance policies with defined incentives and/or defined claim “triggering events” that vary from those presented in this patent application and or provided sample contracts; or name their programs to not include the words “Key Employee Retention.” The overarching premise of this invention is the creation, via the KERI insurance calculation implementation and delivery platform, therein producing an insurance policy to cover the financial risks associated with a company entering into a contract with an employee within which the company is creating a financial obligation as an incentive to employees to remain employed with the company until reaching the contractually defined retirement age or permutation therein contained in the contract.

### DETAILED DESCRIPTION OF THE INVENTION

From a product perspective, an insurance policy is considered a tangible item that can be bought and sold, like any product. The insurance policy itself is the product that can be purchased by the insured, and it has a specific value that is determined by the coverage provided and the cost of the premiums. An insurance policy (product) can be purchased in person at brick-and-mortar offices of the insurance company and/or an insurance brokerage or may be purchased online (electronically) with delivery of the actual policy (product) via email or download. Insurance policies can be and are used by millions of people in the United States alone.

This Key Employee Retention Insurance Policy is designed to insure a Company's financial risk of a Key Employee reaching retirement age with the Employer hence triggering a financial incentive to the Key Employee. The financial incentive(s) as specified in the Policy is written specifically to match the terms and conditions of the accompanying Key Employee Employment Contract between an Employer and its identified Key Employee. The Contract and Policy terms will vary with each Key Employee. The Employer is to be the Policy Owner/Purchaser and the Key Employee will be the Policy Beneficiary. Among the terms in the Key Employee Employment Contract will be four “Event Triggers” as follows:
(1) The event of Employee reaching retirement age stated in the Contract;
(2)The event Employee is rendered Permanently Disabled as described in the Contract;
(3)The event of a layoff/termination as the result of economically forced reduction in staffing levels;
(4) The event of the death of the Employee during the Contract period.

If and when a Triggering Event occurs, a claim is filed by the policy owner with the Insurance Company and upon verification of the claim, the policy proceeds are disbursed either (a) for the full Face Amount of the policy in connection with Event Trigger #1 above, or (b) disbursed in pro-rata fashion in connection with either Event Trigger #2 #3 or #4. The details of the proration are laid out in both the Key Employee Employment Contract and the Key Employee Retention Insurance Policy. Attached herewith as Exhibit #1 is a sample of the Key Employee Employment Contract and Exhibit #2 is a sample the Key Employee Retention Insurance Policy.

Companies across multiple industries have been struggling for years to retain great employees. Acknowledging the existence of alternative Key Employee Retention programs as referred to below, this new and novel Key Employee Retention Insurance Policy product) addresses the financial risks in the form of retention incentives undertaken by Employers to retain great Employees through retirement age. This new and novel insurance policy/product transfers the financial risks taken on by the Employer to the Insurance Company providing/selling these policies.

After conferring with insurance industry experts that include Audit/Tax Preparers, Actuarial Services Professionals, Legal Counsel and Commercial Insurance Brokers, it has been validated that this Key Employee Retention Insurance Policy (product) does not exist in the marketplace to date and is therefore a novel and unique product. Each of the subject matter experts above have commented on what a unique and novel product this is, and confirmed its applicability to any number of industries.

In searching for alternatives to put a Key Employee Retention program in place, I researched all the existing product possibilities including Whole Life Insurance, Non-Qualified Deferred Compensation programs under IRC 409(a), Employee Benefits Trusts under IRC 402(b), Phantom Stock programs which also fall under IRC 409(a), Employee Stock Ownership Plans and more. None of the existing program options exist without a number of detractors plaguing Employers.

One familiar with various insurance policies and programs will know that this Policy/Product does not currently exist, therefore the invention of this Key Employee Retention Insurance Policy (product) is surely unique and certainly “not obvious”. The Key Employee Retention Insurance Policy (product) can be purchased by companies struggling to retain great employees.

This new invention of a Key Employee Retention Insurance Policy (KERI Product) as designed is made up of three essential elements (parts) which when combined are intended to insure a Company's financial risk of an Employee reaching retirement age with the Company hence triggering a financial risk to the Company and a financial incentive to the Employee.

Part One of the KERI Product is a Key Employee Retention Employment Contract (Contract) written by and between the Company and an Employee which details; (a) the duties and scope of employment; (b) position description; (c) confidentiality agreement; (d) obligations of the Employee with respect to their duty to the Company; (e) Employee representation of having no conflicting obligations; (f) defined cash and benefits compensation including salary level, bonus eligibility, vacation and sick leave, and standard Company paid fringe benefits (medical/dental/vision/401(k), etc.).

The Contract then goes on to specify the Key Employee Retention Award(s) being offered to the Employee as consideration for that Employee remaining in the employment of and in good standing with the Company until retirement age (contract specific). The awards are in the form of monetary compensation as defined in the Contract. All awards are based upon the amount stated in the Contract as the “Vested Value”, which is the dollar amount of compensation the Employee will be paid once they reach retirement age. There are any number of “Triggering Events” defined in the Contract which detail the circumstances under which the Employee will be compensated (awarded), and to what degree or amount of compensation is “triggered” as the result of the particular event's occurrence.

“Triggering Event 1” is the event that the Employee remains employed with the Company until he/she reach retirement age as defined in the Contract. Upon the occurrence of Triggering Event 1, the Employee will be paid the Vested Value in whole with the option of receiving the compensation in 5 annual payments, or as one lump sum payment. All such award payments will be included in the Employee's taxable income.

Triggering Event 2 is defined as the Employee sustaining an injury in the workplace environment, and then being determined to have suffered permanent disability and not able to return to work at the Company—or any other company—in any capacity.

Triggering Event 3 is the event of an economic downturn which leads to a decrease in the Company's revenues wherein the Company may be required to terminate the employment Contract either to avoid filing for bankruptcy protection, or in accordance with seeking bankruptcy protection. Economic downturn is defined in the Contract as a percentage drop in Company's annual revenues of 30% or more in any single year, or cumulatively over any three-year span. This percentage is subject to change based upon individual companies'tolerance to revenue fluctuation.

Triggering Event 4 is the event the Employee's death during the Contract period.

In any occurrence of Triggering Events 2, 3 or 4 the Employee will be compensated at a proportionate amount of the Vested Value. The proportionate rate is a function of (1) the length of time between the original Contract date and the Triggering Event date calculated in days divided by (2) the length of time between the original Contract date and the Employees projected retirement date calculated in days.

The Contract is entered into by the Company and the Employee to create an incentive for the Employee to remain employed with the Company until retirement age. In the event that the Employee chooses to willfully resign from the Company, all Retention Awards will be forfeited, and Employee must attest to such forfeiture in writing. The Contract also clarifies the terms under which the Employee may be terminated for cause by the Company, the Contract cancelled and all Retention Awards be forfeited by the Employee. For cause is defined as any of the following:
(i) The “Continued Failure” of the Key Employee to meet performance standards established by the Company. Continued failure shall be defined as the Key Employee's inability to conform to Company's Performance Improvement Plan(s) in which the Key Employee's deficiencies shall be laid out in writing with corrective action(s) to be taken by the Key Employee and communicated/discussed with the Key Employee. Any contrary representations previously made to the Key Employee shall be superseded by this Agreement. This Agreement shall constitute the full and complete agreement between the Key Employee and the Company on the “at will” nature of the Key Employee's Employment, which may be changed only in an express written agreement signed by the Key Employee and a duly authorized officer of the Company; or
(ii) Key Employee's breach of confidentiality as presented in section 1(b).
(iii) Any breach of the Invention, Confidential Information, and Non-Competition Agreement referenced in Section 6 hereof (iv) between the Key Employee and the Company, as determined by the Board of Directors of the Company;
   (v) Conviction of, or a plea of “guilty” or “no contest” to, a felony, or a plea of “guilty” or “no contest” to a lesser included offense in exchange for withdrawal of a felony indictment or a felony charge by indictment if that felony indictment or felony charge by indictment constitutes a crime against another entity, person or a crime involving dishonesty.” arising under the laws of the United States or any state thereof;
(vi) Any act or acts of fraud;
(vii) Any violation of applicable laws, rules or regulations that expose the Company to material damages or material liability; and/or (viii) Material breach by the employee of any material provision of the Employment Agreement that remains uncorrected for 30 days following written notice of such breach to the employee by the company.

Part Two of the KERI Product is the actual Key Employee Retention Insurance Policy (Policy) contract which insures the financial risk(s) taken on by the Company as specified in the Contract. The Policy is written specifically to match the terms and conditions of the accompanying Contract between the Company and its identified Key Employee. The Contract and Policy risk(s) and incentive(s) terms may vary for each Key Employee. The Company will buy these Policies from a duly licensed and registered insurance company and pay insurance premiums as called for in the Policy.

The Company will be the “Insured Party” (Insured) and as such should any of the Triggering Events as described in both the Contract as well as the Policy occur, the Company/Insured shall file a claim with the insurance company and receive the proceeds of the insurance payout. The Company will in turn use those insurance funds to fulfill its obligations to the Employee under the terms of the Contract.

Each Policy will include details contained in its accompanying Contract including all defined Triggering Events as is written into each Contract, as well as the payout amounts-both full Vested Value and prorata calculations. Each Policy and Contract will be analyzed and evaluated by a licensed Actuarial firm connected with the insurance company. The analysis will result in the Actuarial firm recommending to the insurance company the proper amount of premium to charge to the purchaser of a Policy, which in the case of the KERI Product will be the Company as referred to previously.

Part Three is key to the success of the KERI Product, which is to find an insurance company which will write insurance policy coverage to accommodate the nuances and risks of the KERI Product. After conferring with insurance industry experts that include Audit/Tax Preparers, Actuarial Services Professionals, Legal Counsel and Commercial Insurance Brokers, it has been validated that this Key Employee Retention Insurance Policy (product) does not exist in the marketplace to date and is therefore a novel and unique product. Each of the subject matter experts above have commented on what a unique and novel product this is and confirmed its applicability to any number of industries.

In the absence of any existing insurance companies writing policies to cover the KERI Product risks, the one solution for a Company desiring to successfully implement the KERI Product is to establish their own “Captive Insurance Company” (Captive). Captives are insurance companies that are formed and owned by some or all the shareholders, partners, members or sole owners of the Company. which is entering into the Key Employee Retention Employment Contract. Captives are a highly regulated industry, and gaining entry into it is a rigorous process of governmental approvals, IRS elections and compliance with all existing legislature in both the jurisdiction where the Company is domiciled as well as the jurisdiction of where the Captive is domiciled. By complying with all of the aforementioned regulations and laws, once established, the relationship between the Captive and the Company having mutual ownership positions can enjoy favorable tax provisions within the United States Internal Revenue Service and possibly in the domicile of the Captive.

Once approved, established, funded and in business, the Captive insurance company will write the Key Employee Retention Insurance Policies which will be purchased by the Company having entered into the Key Employee Retention program. Once again, in order to maintain compliance in all jurisdictions, the Captive will contract with an actuarial firm and a legal team to review, analyze and price each KERI Policy. The actuarial firm will analyze the expected loss ratios connected with each of the Triggering Events contained in the contract/policy. Key components in this analysis include Employee's current age, gender, incentive amount, probability of Employee surviving to retirement age, probability of the Employee becoming permanently disabled, probability of Employee death, probability of an economic downturn, and the expected payouts for each Triggering Event.

From the legal perspective, each Policy and accompanying Contract should be reviewed for accuracy and compliance with jurisdictional requirements to meet the test of establishing (a) contractual risk, and (b) confirmation that these risks are in fact insurable risks.

Included in the legal analysis should be a comprehensive review of the following IRS regulations under IRC Title 26 and specifically IRS Notice 2016-66:

### INFRA: “TRANSACTIONS OF INTEREST”

Acknowledging the existence of alternative Key Employee Retention programs as referred to below, this new and novel KERI Product addresses the financial risks in the form of retention incentives undertaken by Employers to retain great Employees through retirement age. This new and novel KERI Product transfers the financial risks taken by the Employer to the Insurance Company providing/selling these policies.

In searching for alternatives to put a Key Employee Retention program in place, research was conducted into alternative existing product possibilities including Whole Life Insurance, Non-Qualified Deferred Compensation programs under IRC 409(a), Employee Benefits Trusts under IRC 402(b), Phantom Stock programs (which also fall under IRC 409(a)), Employee Stock Ownership Plans and more. None of the existing program options exist without a number of detractors plaguing Employers. Being quite familiar with various insurance policies and programs, I know that this Policy/Product does not currently exist, therefore the invention of this Key Employee Retention Insurance Policy (product) is surely unique and certainly “not obvious”. The Key Employee Retention Insurance Policy (product) can be purchased by companies struggling to retain great employees. There are many Commercial Insurance programs available that provide insurance policies to businesses for any myriad of risks including general liability, automobile, business property, workers'compensation, professional liability, directors and officers, employment practices, cyber security and more. While insurance policies do exist insurance policies that follow/cover the financial risks of other contracts such as Subcontractor Default Insurance Policies which insure the risk of default on a construction subcontract, there is no readily available insurance product which cover the financial risks associated with Key Employee Retention Employment Contracts.

The most widely used insurance policies purchased in connection with Key Employee Retention are in the form of Whole Life Insurance or Universal Life Insurance. These policies provide coverage triggered by the death of the employee, but also include a build-up of a “cash value” for which the policy can be converted into at any time including the employee reaching retirement age. The inherent difference between these types of policies is that (1) they are expensive for the Company to pay for, (2) offer no control over the policy premiums once paid and (3) only a small portion of the policy premiums are actually contributed to eh “cash value” of the policy, while the brunt of the premiums go directly the revenues of the insurance carrier. Furthermore, these policies do not allow for the flexibility of the Key Employee Retention Insurance (KERI) policy with respect to the various claim triggering events.

There also exist other methods/programs that provide incentive(s) for Key Employees to remain with their companies in the form of (1) Non-Qualified Deferred Compensation Programs under IRS Code 409(a) which allow for (i) employees to defer current period income into an irrevocable trust and (ii) also allow employers the ability to make contributions to the same trust for the benefit of the employee(s). (2) Irrevocable Employee Trust Programs under IRS Code 402(b) which allows only the employer the ability to make contributions to the trust. The inherent downsides to both of these programs is that the employer receives no tax deduction until such time that the employee's portion of the trust is “vested” or paid out, which could be in twenty years or more. Secondly, the employers'contributions to these plans is considered “after tax” contributions meaning that for every amount contributed to the program, the company has already (or will) pay tax on the amount in the current tax period.

The entire concept of the Key Employee Retention Insurance Policy (product) is designed to insure the contractually obligated financial risks contained within a Key Employee Retention Employment Contract. It is conceivable that some other company(ies) may develop or write employment contracts and insurance policies with defined incentives and/or defined claim “triggering events” that vary from those presented in this patent application and or provided sample contracts; or name their programs to not include the words “Key Employee Retention”. The overarching premise of this invention is the creation of an insurance policy to cover the financial risks associated with a company entering into a contract with an employee within which the company is creating a financial obligation as an incentive to employees to remain employed with the company until reaching the contractually defined retirement age or permutation therein contained in the contract.

It should be noted that the features illustrated in the Detailed Description of the invention/product are not necessarily all inclusive, and features of one embodiment may be employed with other embodiments as skilled lawyers and legal representatives would recognize, even if not explicitly stated herein.

1. An insurance calculation implementation and delivery platform which gives Key Employees at a Company an incentive (and gives Insurance Providers and Captives an incentive), for Key Employees to stay with the Company until retirement payout-age given the satisfaction of predetermined performance obligations of Employee as calculated by the algorithmic processes of the herein-disclosed invention, given specific procedures for Employers regarding employment appraisals and improvement requirements, and given the implementation of arm's-length contracts, actuarially-determined premiums, and assuming claims are paid from a separately maintained account, wherein the platform weighs the aggregate of premiums received and weighs the aggregate liability assumed by the Captive per Employee, and wherein the platform insures the Company's loss in the event the employee retires, and wherein the Insurer has determined the adequate cost of these risks consistent with insurable interest, while effectively nulling the risks of employee death and the risk of employee permanent disability through the mathematical system of the invention's platform as described above such that the platform provides a financially safe harbor for the Captive underwriter and provides a financially attractive product for the Insurance Provider and for the [parent] Company, noting that the Captive Insurance Provider often underwrites risks for at least twelve entities of a [parent] Company, and the KERI method platform accounts for between about five percent and about fifteen percent of the total risk insured by the Captive.

2. The invention of claim 1 wherein the Captive Insurance Provider underwrites risks for at least twelve entities of a [parent] Company.

3. The invention in claim 1 wherein the platform accounts for between about five percent and about fifteen percent of the total risk insured by the Captive.

4. An insurance calculation implementation and delivery platform which gives Key Employees at a Company an incentive (and gives Insurance Providers and Captives an incentive), for Key Employees to stay with the Company until retirement payout-age given the satisfaction of predetermined performance obligations of Employee, given specific procedures for Employers regarding employment appraisals and improvement requirements,
and given the implementation of arm's-length contracts, actuarially-determined premiums, assuming claims are paid from a separately maintained account, wherein
the platform weighs the aggregate of premiums received and weighs the aggregate liability assumed by the Captive per Employee,
wherein the platform insures the Company's loss in the event the employee retires, and wherein the Insurer has determined the adequate cost of these risks consistent with insurable interest, while effectively nulling the risks of employee death and the risk of employee permanent disability,
such that the platform provides a financially safe harbor for the Captive underwriter and provides a financially attractive product for the Insurance Provider and for the [parent] Company.

5. The invention of claim 4 wherein the Captive Insurance Provider underwrites risks for at least twelve entities of a [parent] Company.

6. The invention in claim 4 wherein the platform accounts for between about five percent and about fifteen percent of the total risk insured by the Captive.

7. The invention of claim 4 wherein the platform further provides a feasibility calculation producing data reflecting actuarially-determined premiums, achieving the optimal desired risk distribution and optimal concentration of risk.

8. An insurance calculation implementation and delivery platform producing an Insurance product with optimal distribution of risk, producing contracts with the longest allowable vesting age, with an optimal risk distribution range.

9. The invention of claim 8 with a risk distribution ranging from about 0.91% to about 10.69%.

10. The invention of claim 8 instituted in an entity pool comprising at least twelve entities of a [parent] Company.
